(19) United States
(12) Patent Application Publication
(10) Pub. No.: US 2025/0203733 A1
(43) Pub. Date: Jun. 19, 2025

(54) Light Emission Circuit and Method for Handheld Tool

(71) Applicant: Robert Bosch GmbH, Stuttgarg (DE)

(72) Inventors: Ralph Kamarski, Inverness, IL (US); Audel Gutierrez, Aurora, IL (US); Saurabh Nanavati, Westmont, IL (US)

(21) Appl. No.: 18/973,684

(22) Filed: Dec. 9, 2024

Related U.S. Application Data
(60) Provisional application No. 63/612,076, filed on Dec. 19, 2023.

(51) Int. Cl. H05B 47/105; B25F 5/02; B26B 25/00; F21V 33/00; F21Y 105/18; F21Y 113/00; F21Y 115/10; H05B 45/30

(52) U.S. Cl. CPC H05B 47/105; F21V 33/0084; H05B 45/30; B26B 25/00; F21Y 2105/18; F21Y 2113/00; F21Y 2115/10

(57) ABSTRACT

A rotary tool having a light-emitting element and a control circuit for the light-emitting element. The light-emitting element may comprise one or more light emitting diodes at least partially disposed within a nosecap of the rotary tool. Control of the illumination of the light-emitting element may be accomplished according to a method of operating the control circuit.

### TECHNICAL FIELD

This disclosure relates to power tools, and more specifically to handheld rotary tools.

### BACKGROUND

Rotary tools provide users with an effective means of performing detailed work. However, working environments of such tools may not always be optimal for visual conditions to observe the work. For example, lighting conditions may be less than ideal, or the work may be required in locations where conventional and overhead lighting is difficult.

What is desired is a rotary-tool having ergonomic tool-mounted task lighting, to provide direct light on the workpiece in any desired condition. Even more advantageous would be a rotary tool having light with additional controllable features to provide the most desirable conditions for a user of the rotary tool.

### SUMMARY

One aspect of this disclosure is directed to light-emission circuit for a handheld tool, the circuit comprising at least three nodes. The first node provides a first input voltage reference. The second node provides a second input voltage reference, the second node being separated from the first node by a capacitor. The third node is separated from the first node by a diode restricting current flow between the first node and the third node, and the third node is further separated from the second node by a capacitor in parallel with a light emission branch. The light emission branch comprises a first sub-branch having a light emitting element and a second sub-branch having a transistor array. The light emitting element may comprise one or more light emitting diodes (LEDs). The transistor array may comprise one or more bipolar junction transistors (BJTs).

Another aspect of this disclosure is directed to a light-emission circuit for a handheld tool, the circuit having 4 nodes, a first input voltage reference, a second input voltage reference, a light emitting diode (LED) array, and a transistor array. The first node is connected to the first input voltage reference. The second node is connected to the second input voltage reference and separated from the first node by a first capacitor. The third node is separated from the first node by a Zener diode restricting the current flow between the first node and the third node. The third node is further separated from the second node by a second capacitor and a light emission branch comprising the LED array and the transistor array. The capacitor and the light emission branch are in parallel. The fourth node is disposed within the light emission branch, the fourth node, separated from the third node by the LED array, and separated from the second node by a sub-path of the transistor array. The transistor array comprises a pair of bipolar junction transistors (BJTs), wherein the collector of a first BJT is connected to the fourth node, the base of the first BJT is connected to the collector of a second BJT, and the emitter of the first BJT is connected to the base of the second BJT and separated from the second node by a resistor. The collector of the second BJT is separated from the third node by a resistor, and the emitter of the second BJT connected to the second node.

A further aspect of this disclosure is directed to a rotary tool comprising a body, an electric motor at least partially disposed within the body, a rotating shaft coupled to the electric motor, a nosecap having electrical contacts and at least partially surrounding the rotating shaft during operation of the rotary tool, and a switch in electrical communication with the electrical contacts of the nosecap. The electric motor is configured to rotationally drive the rotating shaft. The switch engages and disengages the electric motor. The nosecap further comprises a light-emitting diode (LED) disposed thereupon, the LED illuminating when the electric motor is engaged, the LED arranged to project light toward a working end of the rotating shaft when illuminated.

Another aspect of this disclosure is directed to a method for controlling a light-emitting diode (LED) disposed upon a rotary tool. The method includes steps of applying a voltage to a control circuit in response to the engagement of an electric motor of the rotary tool, utilizing the voltage to illuminate the LED, and illuminating the LED after a start condition is detected by the control circuit until a stop condition is detected by the control circuit. The engagement of the electric motor is controlled by a switch. The control circuit comprises a transistor array.

The above aspects of this disclosure and other aspects will be explained in greater detail below with reference to the attached drawings.

### BRIEF DESCRIPTION OF THE DRAWINGS

FIG. 1 is an illustration of a rotary tool.

FIG. 2 is a close-up illustration of particular elements of the rotary tool of FIG. 1.

FIG. 3 is a circuit diagram of a lighting control circuit for a rotary tool.

FIG. 4 is a circuit diagram of a lighting control circuit for a rotary tool showing particular features thereof.

FIG. 5 is an illustration of a physical layout of the circuit board of FIG. 4 on a circuit board for placement inside the nosecap of a rotary tool.

FIG. 6 is a flowchart illustrating a method of utility for controlling the on-tool lighting features of a rotary tool.

FIG. 7 is a flowchart illustrating a method of utility for controlling the on-tool lighting features of a rotary tool.

FIG. 8 is a first timing chart illustrating a method of operation for the on-tool lighting features of a rotary tool.

FIG. 9 is a second timing chart illustrating a method of operation for the on-tool lighting features of a rotary tool.

### DETAILED DESCRIPTION

The illustrated embodiments are disclosed with reference to the drawings. However, it is to be understood that the disclosed embodiments are intended to be merely examples that may be embodied in various and alternative forms. The figures are not necessarily to scale and some features may be exaggerated or minimized to show details of particular components. The specific structural and functional details disclosed are not to be interpreted as limiting, but as a representative basis for teaching one skilled in the art how to practice the disclosed concepts.

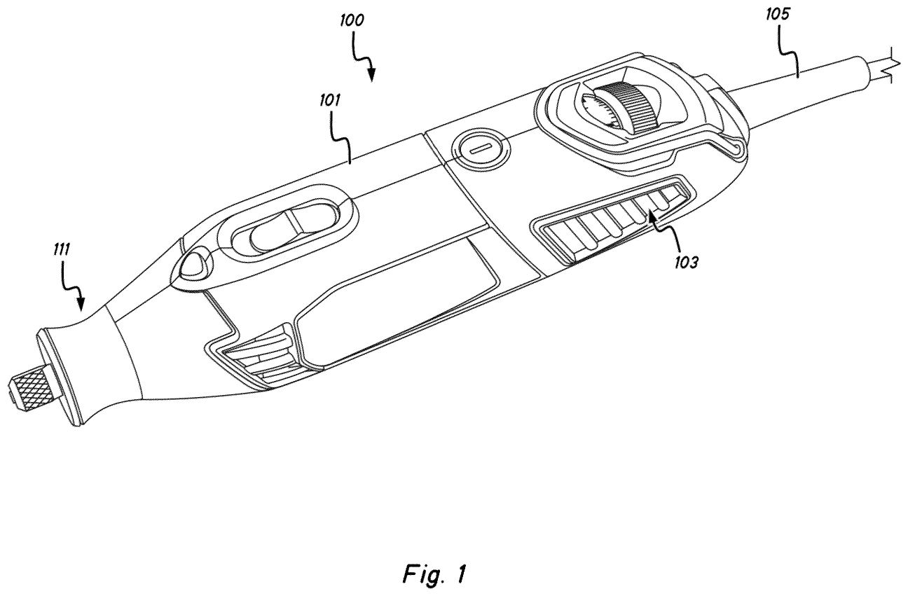

FIG. 1 is an illustration of a rotary tool 100 according to one embodiment of the teachings disclosed herein. Rotary tool 100 comprises a body 101 that houses an electric motor 103. Electric motor 103 facilitates the primary operation of rotary tool 100 by utilizing power from a power source 105. In the depicted embodiment, power source 105 comprises an electrical cable connected to an external electrical source, such as an electrical outlet or a power transformer, but other embodiments may comprise other configurations without deviating from the teachings disclosed herein. Other embodiments may comprise a cordless configuration having a battery without deviating from the teachings disclosed herein. In the depicted embodiment, a user may grip rotary tool 100 along body 101 or may grip along a neck 111 (utilizing a so-called “pencil grip”) for finer motor control during operation.

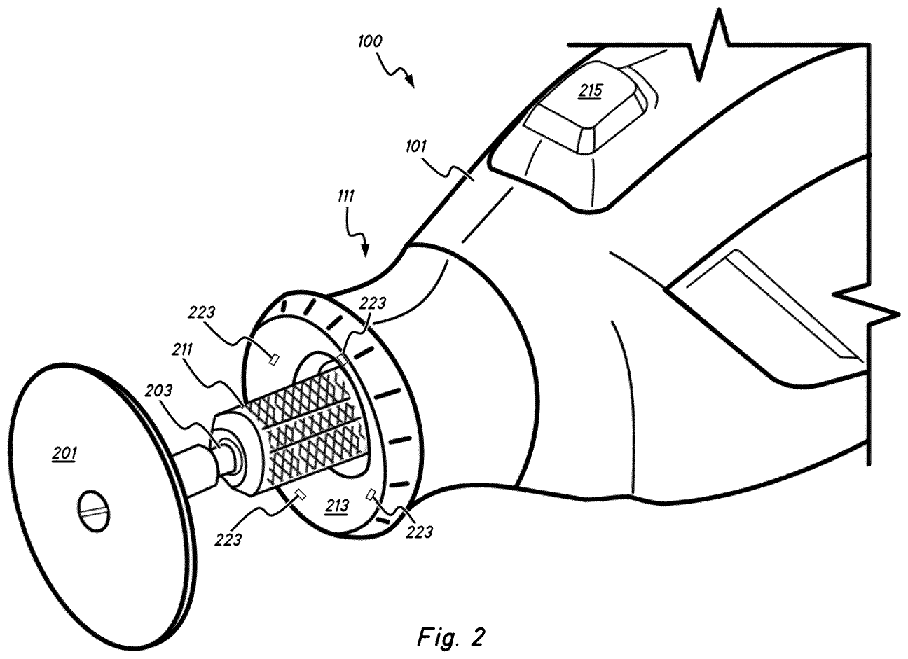

FIG. 2 provides a close-up illustration of additional features of the operational elements of rotary tool 100. In this depiction, a tool attachment 201 is rotated by a rotating shaft 203 this is rotationally driven by electric motor 103 (not shown; see FIG. 1). In the depicted embodiment, tool attachment 201 comprises a cutting disk, but other embodiments may comprise any other rotary tool attachment known to one of ordinary skill without deviating from the teachings disclosed herein. Tool attachment 201 is retained in position with respect to rotating shaft 203 by a retainer 211. Rotating shaft 203 and retainer 211 extend out from body 100 through a nosecap 213, which defines one end of the body 101 nearest to the tool attachment 201 during operation of rotary tool 100.

In the depicted embodiment, power to the electric motor 103 is controlled using a switch 215. Other functions may be controlled by utilizing switch 215 or other switches or controls (not shown) of rotary tool 100 without deviating from the teachings disclosed herein.

In the depicted embodiment, nosecap 213 additionally comprises a number of light emitting diodes (LEDs) 223 that are at least partially disposed thereon. LEDs 223 are configured to illuminate with power provided by power supply 105 (see FIG. 1) during operation of rotary tool 100. The illumination of LEDs 223 is directed toward tool attachment 201 in order to provide light for a user while operating rotary tool 100. In the depicted embodiment, LEDs 223 are spaced on nosecap 213 at regular angular intervals with respect to rotating shaft 203, but other embodiments may comprise different arrangements without deviating from the teachings disclosed herein. In the depicted embodiment, rotary tool 100 comprises a plurality of 4 LEDs 223, but other embodiments may comprise a different number of LEDs 223 without deviating from the teachings disclosed herein.

Although the depicted embodiment comprises a plurality of light-emitting diodes, other embodiments may comprise other light-emitting elements without deviating from the teachings disclosed herein. In such embodiments, rotary tool 100 may comprise incandescent lights, point lasers, sweep lasers, compact fluorescent lighting, compact neon lighting, or any other light-emitting element known to one of ordinary skill without deviating from the teachings disclosed herein.

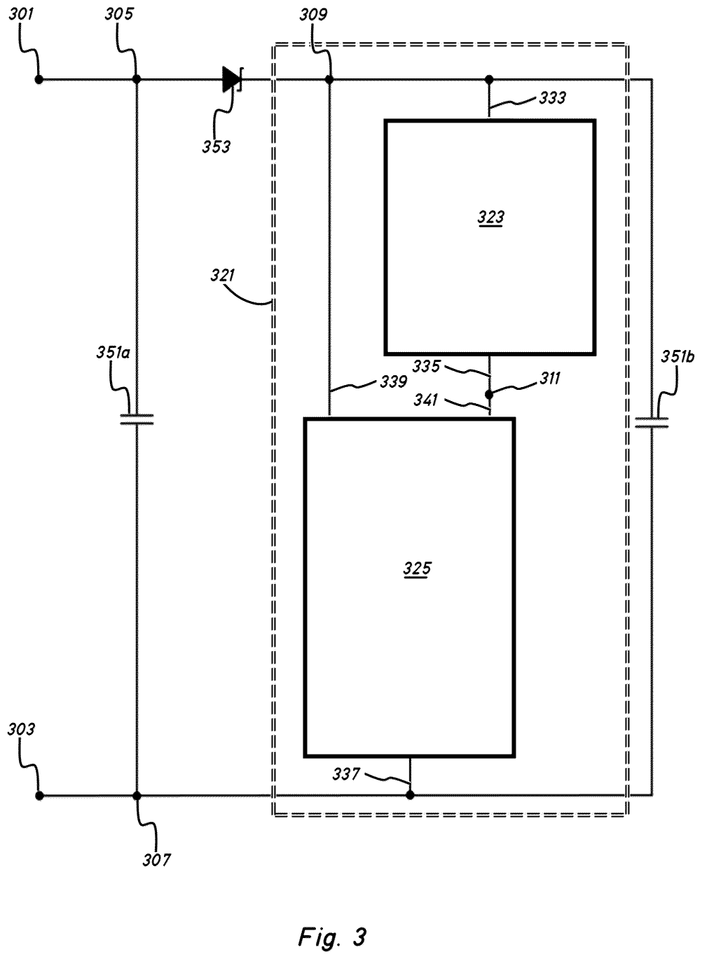

In the depicted embodiment, each of LEDs 223 are controlled by a control circuit (not shown; see FIG. 3-5) and may be illuminated in response to detection of a start condition until a stop condition is detected. By way of example, and not limitation, a start condition may comprise engagement of electric motor 103 and a stop condition may comprise disengagement of electric motor 103. In such embodiments, one or more of LEDs 223 may de-illuminate (i.e., discontinue the emission of light) in response to disengagement of the electric motor 103.

Some users may instead prefer to have discrete control over the operation of rotary tool 100 and also illumination status of one or more of LEDs 223. In the depicted embodiment, the illumination status of the LEDs 223 may be controlled based upon the behavior with which a user toggles switch 215. By way of example, and not limitation, switch 215 may comprise a press switch and the LEDs 223 may illuminate only if the electric motor 103 is engaged by a “long press” engagement of switch 215, such as the user pressing switch 215 for a minimum threshold value of time. In such embodiments, a “short press” activation of electric motor 103 would comprise engagement of switch 215 for less than a predetermined period of time. In response to a short press, the electric motor 103 may engage, but LEDs 223 would not illuminate. In such embodiments, a “long press” activation of electric motor 103 would result in both electric motor 103 and one or more of LEDs 223 activating.

Other embodiments may exhibit the inverse behavior without deviating from the teachings disclosed herein. In such embodiments, a user engaging a “short press” may illuminate one or more of LEDs 223, whereas a “long press” may activate electric motor 103 without illuminating any of LEDs 223. In some such embodiments, one or more of LEDs 223 may illuminate in response to initial engagement of a “long press” and then de-illuminate upon completion of the long press (i.e., upon reaching the threshold value of time of continuous engagement of switch 215).

The threshold value of time to delineate between a “short press” and a “long press” may be predetermined by design. In the depicted embodiment, a threshold value of 3 seconds is used, but other embodiments may comprise other threshold values without deviating from the teachings disclosed herein. By way of example, and not limitation, the threshold value of time may be preselected as any value between 1-5 seconds without deviating from the teachings disclosed herein.

Other embodiments may comprise other configurations of LEDs 223 without deviating from the teachings disclosed herein. By way of example, and not limitation, additional behaviors of LEDs 223 may be realized such as changes to brightness level, activation of only a portion of the plurality of LEDs, blinking or flashing patterns, or other known illumination behaviors without deviating from the teachings disclosed herein. In some embodiments, different behaviors may be realized in response to a predetermined number of presses of switch 215 according a preprogrammed sequence. In such embodiments, the behavior of each LED may be determined based upon how many toggles of switch 215 a user engages, and the behaviors may rotate according to the preprogrammed sequence. In such embodiments, all of the LEDs 223 may behave independently in response to the same number of toggles of switch 215, or two or more LEDs 223 may behave similarly without deviating from the teachings disclosed herein.

Switch 215 may comprise a toggle switch, potentiometer, stepped potentiometer, or encoder for a micro-controller without deviating from the teachings disclosed herein. Critically, although switch 215 selectively controls the behavior of LEDs 223, the electric motor 103 of rotary tool 100 should operate independently of the status of LEDs 223. In some embodiments, such as those utilizing a passive toggle switch configuration of switch 215, the illumination of one or more LEDs 223 may be dependent upon the engagement status of electric motor 103 without deviating from the teachings disclosed herein. In some embodiments, a control mechanism other than switch 215—such as a second switch, a button, a body-heat activated thermal switch, or any other known mechanism—may be utilized to control LEDs 223 without deviating from the teachings disclosed herein. In some embodiments having a second control mechanism for LEDs, the second control mechanism may be disposed at least partially within nosecap 213 without deviating from the teachings disclosed herein.

Control of the behavior of LEDs 223 relies upon a control circuit (not shown). FIG. 3 provides an illustration of one particular embodiment of a control circuit for LEDs in handheld tool (such as rotary tool 100; see FIG. 1, 2). The control circuit comprises a first input voltage reference 301 and a second input voltage reference 303. First input voltage reference 301 may additionally be referred to as a “high input voltage reference” or simply “high input voltage.” Second input voltage reference 303 may additionally be referred to as a “low input voltage reference” or simply “low input voltage”. In the depicted embodiment, the circuit comprises a first node 305, second node 307, third node 309, and fourth node 311. Each of the nodes provides a reference point for a particular voltage value for electrically-connected points in communication with the node, and are introduced here for the purpose of convenience in discussion of the circuit.

Functionally, light emission functions of the circuit are accomplished by elements of a light emission branch 321, which includes a first sub-branch 323 comprised of light-emitting elements (hereinafter “light-emitting” (LE) array 323) and a second sub-branch 325 comprised of a transistor array (hereinafter “transistor array 325) suitable to control the light-emission behavior of LE array 323. The LE array 323 comprises a first high pin 333 (hereinafter “LE high pin” 333) connected to third node 309 and a first low pin 335 (hereinafter “LE Low pin 335) connected to fourth node 311. The transistor array 325 comprises a second low pin 337 (hereinafter “TA low pin” 341) connected to second node 307. The transistor array 325 additionally comprises a plurality of second high pins (hereinafter “TA high pins”). In the depicted embodiment, these include TA high pin 339 and TA high pin 341. TA high pin 339 is connected to third node 309 and TA high pin 341 is connected to fourth node 311.

The control circuit features additional elements to control for unwanted behaviors of voltage and current within the circuit. Second node 307 is separated from first node 305 and third node 309 by capacitors 351. Capacitors 351 help to shunt high-frequency current away from the light-emission branch 321, which can reduce undesirable flickering or flashing of LE array 323. Capacitors 351 may comprise different capacitance values or identical values without deviating from the teachings disclosed herein.

Additionally, first node 305 is separated from third node 309 by a diode 353 to protect light emission branch 321 from undesirable current flow. In the depicted embodiment, diode 353 comprises a Zener diode that only permits current flow from first node 305 toward third node 309, which in turn protects the elements of LE array 323 and transistor array 325 as well as prevents undesirable behaviors of the light emission branch 321 sub-branches that may be caused by current flowing in an undesired direction. In the depicted embodiment, diode 353 may comprise a Zener diode, but other embodiments may comprise other configurations without deviating from the teachings disclosed herein.

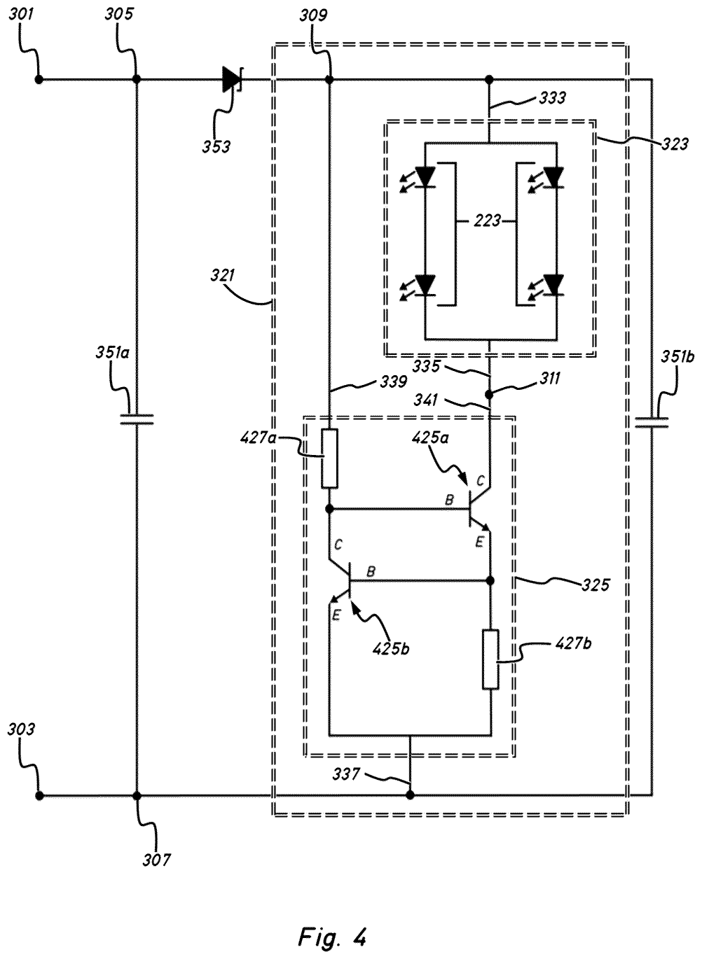

The circuit of FIG. 3 provides a generalized layout for the functions of light control. FIG. 4 is a circuit diagram for a similar control circuit having particular arrangements for LE array 323 and transistor array 325.

In the depicted embodiment, LE array 323 comprises a plurality of LEDs 223 (see also FIG. 2). In this embodiment, LE array 323 comprises 4 LEDs 223 arranged such that a pair of LEDs 223 wired in series comprise a sub-path of the array in a parallel with another identical sub-path. Other embodiments may comprise other arrangements, including arrangements featuring a different number of LEDs 223, without deviating from the teachings disclosed herein. Other embodiments may comprise additional or different light-emission elements to LEDs 223 without deviating from the teachings disclosed herein. Such embodiments may comprise incandescent lights, point lasers, sweep lasers, compact fluorescent lighting, compact neon lighting, or any other light-emitting element known to one of ordinary skill instead of or in addition to light-emitting diodes without deviating from the teachings disclosed herein.

In the depicted embodiment of FIG. 4, transistor array 325 comprises a plurality of transistors 425. In the depicted embodiment, each of transistors 425 comprises a bipolar junction transistor (BJT), but other embodiments may comprise other configurations without deviating from the teachings disclosed herein. Transistor array 325 additionally comprises a number of impedance loads 427 to provide control over the voltage dropped across various elements of transistors 425. In the depicted embodiment, impedance loads 427 comprise resistors, but other embodiments may utilize other impedance loads exhibiting reactance without deviating from the teachings disclosed herein.

In the depicted embodiment, a first BJT 425a is connected to fourth node 311 at the collector terminal via TA high pin 341. The base terminal of first BJT 425a is connected to the collector terminal of second BJT 425b and separated from third node 309 via resistor 427a. The emitter terminal of first BJT 425a is connected to the base terminal of second BJT 425b and separated from second node 307 by resistor 427b. The emitter terminal of BJT 425b is connected to second node 307 via TA low pin 337. This configuration of transistor array 325 results in a controlled and continuous current draw through the transistor array 325. Because of this continuous current draw, a consistent voltage is applied across the LED array 323, and a continuous current draw results across the entirety of light emission branch 321. This continuous current draw advantageously results in a steady illumination of LEDs 223, providing for an ergonomic and reliable light emission.

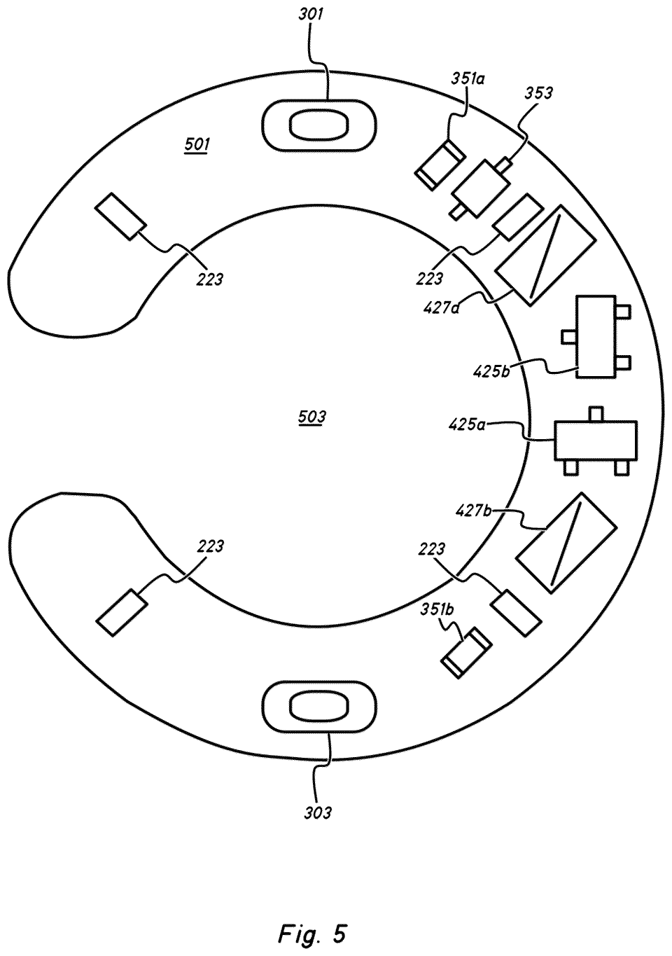

The circuit diagrams of FIG. 3 and FIG. 4 are illustrated for clarity of understanding the electrical connections, node-voltage analysis, and current-flow analysis, but do not limit the arrangement or topology of the circuit. FIG. 5 presents an illustration of a circuit board 501 suitable for implementation with a rotary tool (such as rotary tool 100; see FIG. 1). Circuit board 501 comprises the same topology of electrical connections as illustrated in the diagram of FIG. 4, but laid out in a manner suitable for use within an associated rotary tool. The view of FIG. 5 comprises a top view of the layout of circuit board 501, with the elements mounted thereupon. In the depicted embodiment, circuit board 501 comprises a printed circuit board (PCB), with the electrical connections routed on the either side of the circuit board (not shown), but other embodiments may comprise other configurations without deviating from the teachings disclosed herein. In the depicted embodiment, circuit board 501 is configured to be disposed within a nosecap of a rotary tool (such as nosecap 213; see FIG. 2). In such embodiments, the associated nosecap may comprise a retaining element (not shown) to retain the placement of circuit board 501 within the nosecap in a secure position. This retention advantageously protects the internal elements of rotary tool 501, including the circuit elements of circuit board 501. Circuit board 501 additionally is designed with a gap 503 configured to accommodate for a rotating shaft of a rotary tool (such as rotating shaft 203; see FIG. 2). Gap 503 accommodates a mechanical connection between a rotating shaft of a rotary tool with a drive element (such as electric motor 103; see FIG. 1). Other embodiments may comprise other arrangements without deviating from the teachings disclosed herein.

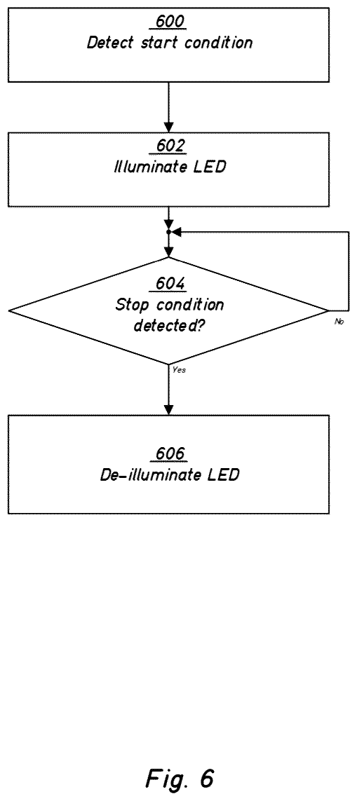

FIG. 6 is flowchart illustrating a method of utilizing the light-emissions functions of a rotary tool (such as rotary tool 100; see FIG. 1) with a control circuit (such as the circuit of FIG. 3). The method begins at step 600 with the detection of a start condition. In the depicted embodiment, the start condition may comprise activation of the motor of the rotary tool, engagement of a switch, or a combination of both. In the depicted embodiment, the motor of the associated rotary tool may be an electric motor powered by an electric power source, and the power source may additionally provide the requisite electric signal to a control circuit of the rotary tool. Once the start condition is detected, a light-emission branch of the control circuit is activated, and associated light-emitting elements are illuminated. In this embodiment, the light-emitting elements comprise light emitting diodes (LEDs) but other embodiments may comprise other configurations without deviating from the teachings disclosed herein.

After illumination, the method proceeds to step 604, where the circuit monitors for a stop condition. In the depicted embodiment, the stop condition may comprise disengagement of the electric motor or the switch. The stop condition may additionally comprise a “long press” of the switch, which will be interpreted to de-illuminate the LEDs without disengaging the electric motor of the rotary tool. A “long press” is achieved by continuous engagement of the associated switch past a predetermined threshold of time. In the depicted embodiment, the predetermined threshold of time may be 3 seconds, but other embodiments may comprise other configurations without deviating from the teachings disclosed herein. This behavior of the control circuit maybe accomplished by a transistor array, such as transistor array 325 (see FIG. 3; FIG. 4), but other embodiments may comprise other configurations without deviating from the teachings disclosed herein.

Once a stop condition has been detected, the method proceeds to step 606, where the LEDs are de-illuminated, and the method ends. In some embodiments, the method may loop back to step 600 to detect a start condition again after ending, such as when a user continues to actively use the rotary tool without illumination.

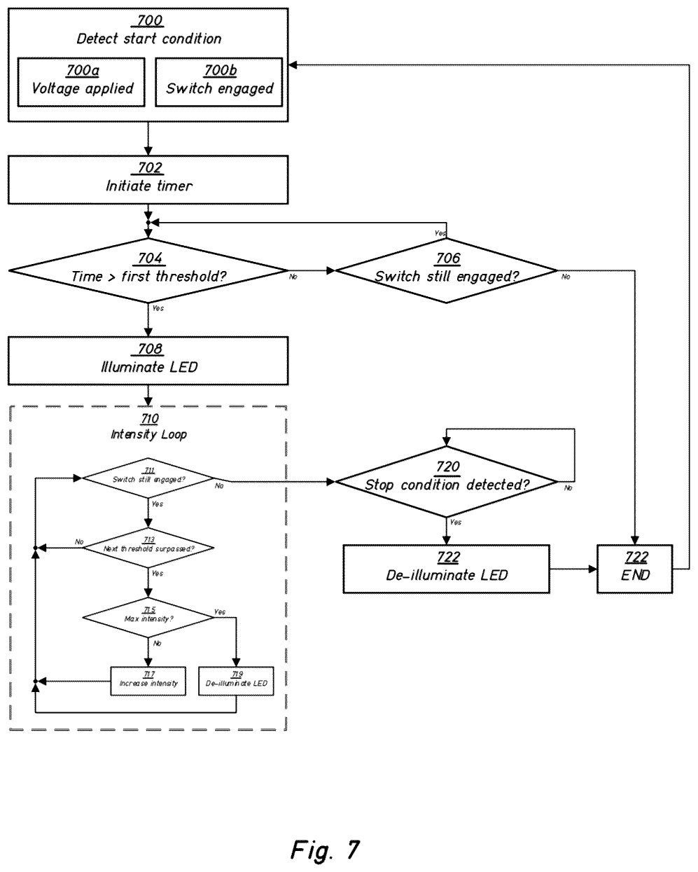

FIG. 6 illustrates a first embodiment of illumination behavior, but more elaborate functions may be desired. FIG. 7 provides an illustration of an illumination method having additional features.

The method begins at step 700, where a start condition has been detected. In the depicted embodiment, the start condition comprises a voltage applied to the circuit at sub-step 700a and a switch being engaged at sub-step 700b. Other embodiments may comprise a different set of start conditions, or an alternative configuration of start conditions. By way of example, and not limitation, an alternative embodiment may initiate the method in response to only one of sub-step 700a or sub-step 700b without deviating from the teachings disclosed herein.

After the start condition is detected, a timer is initiated at step 702, and the method waits at step 704 for a first time threshold to be reached. If the threshold is not yet reached, the method proceeds to step 706 to determine if the switch is still engaged. If the switch is not engaged, the method ends, but if the switch remains engaged, the method returns to step 704 to measure the timer again. Once the first threshold has been reach, the method proceeds to step 708 to illuminate a light-emitting element of the rotary tool, in this embodiment a light-emitting diode (LED). Other embodiments may comprise other light-emitting elements without deviating from the teachings disclosed herein. In the depicted embodiment, the first threshold may comprise a time window of 1-5 seconds, such as 3 seconds, but other embodiments may comprise other values for the first threshold without deviating from the teachings disclosed herein.

After the LED is illuminated, an “intensity loop” sub-process 710 is initiated to adjust the intensity or visual brightness of the illumination. The sub-process first checks that the switch is still engaged at sub-step 711, and if not the sub-process 710 is ended and proceeds to the next step of the method. However, so long as the switch is still engaged, the sub-process continues to sub-step 713 to check if the timer has surpassed a next threshold. In the depicted embodiment, thresholds may be passed with regular intervals of time, such as every 1-5 seconds. By way of example, and not limitation, each next threshold beyond the first threshold (of step 704) may comprise a time window of 1 second, but other embodiments may comprise other configurations without deviating from the teachings disclosed herein. If the switch remains engaged past the next threshold, the sub-process continues to sub-step 715, where it is determined if the LED is already illuminated at the maximum intensity. If not, the intensity of illumination is increased at sub-step 717. If the maximum intensity has been achieved, the sub-process instead de-illuminates the LED at sub-step 719.

After the change in intensity at either of sub-steps 717 or 719, the sub-process returns to sub-step 711. This sub-process 710 advantageously iteratively loops through the steps for as long as the user engages the switch, resulting in a continuous sequence of intensity changes, including a minimum intensity, a maximum intensity, and an “off”. The intensity changes advantageously occur at regular intervals for as long as the switch is engaged.

In the depicted embodiment, each intensity increase may correspond to a percentage increase in light energy output. By way of example, and not limitation, there may be 4 intensity intervals in a rotary tool comprising 4 distinct LEDs, with each intensity interval corresponding to an additional one of the 4 LEDs being illuminated. In another embodiment, each intensity interval may correspond to a 10% increase in light energy output without deviating from the teachings disclosed herein. In such an embodiment, there may be 10 intensity levels in sequence. In some embodiments, each intensity interval may correspond to a different output pattern amongst a plurality of LEDs. By way of example, and not limitation, some such embodiments may rotate illumination of a single LED in an array of 4 LEDs before illuminating different pairs of the 4, before finally illuminating all 4 LEDs simultaneously. This configuration may advantageously provide different desirable light distributions that better illuminate a workpiece during operation of the rotary tool. Some embodiments may comprise programmable intensity settings without deviating from the teachings disclosed herein. In such embodiments, the number of intensity levels, sequence of the intensity levels, or threshold times for selecting a respective intensity level may be effectively arbitrary and selected by a user or manufacturer without deviating from the teachings disclosed herein.

Once it is detected that the switch is no longer engaged at sub-step 711, the method exits the intensity loop sub-process 710 and proceeds to step 720, where the tool waits for a stop condition to be detected. In the depicted embodiment, the stop condition comprises either a discontinuation of voltage applied to the circuit (such as deactivation of the power source for the rotary tool) or a re-engagement of the switch. In some alternative embodiments, re-engagement of the switch may return to one of the sub-steps of intensity loop 710 without deviating from the teachings disclosed herein. Once the stop condition is detected, the method de-illuminates the LED at step 722. If the LED is already de-illuminated (such as during sub-step 719), this step behaves as a placeholder step to ensure that the LED is de-illuminated in other conditions. After step 722, the method ends at step 724. However, in the depicted embodiment, after the method ends, it may return to step 700 to detect start conditions again, such as with continued use of the motor of the rotary tool in the de-illuminated state. Other embodiments may not return to the initialization step 700 without deviating from the teachings disclosed herein.

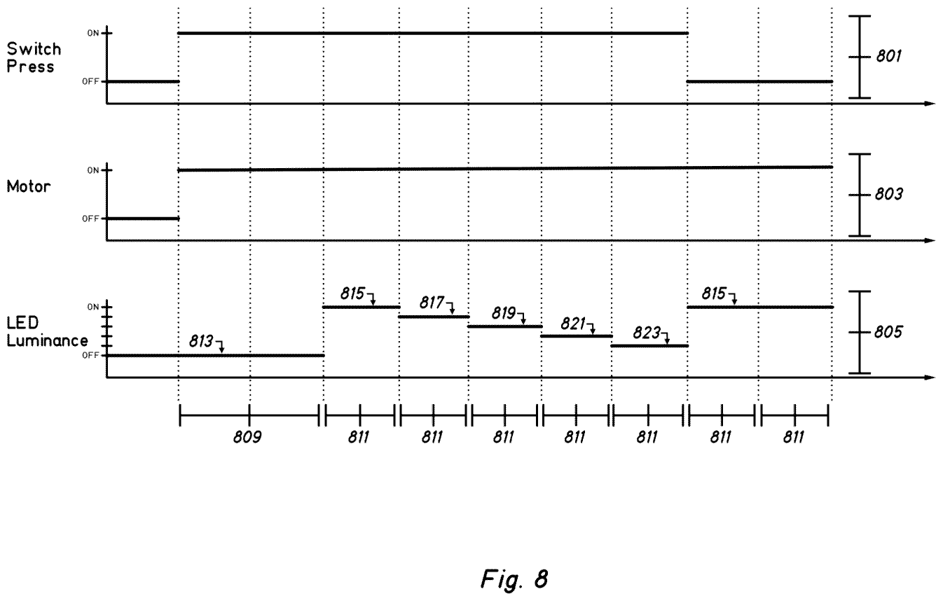

FIG. 8 presents a timing chart illustrating the behavior of a rotary tool (such as rotary tool 100; see FIG. 1) according to one embodiment of the inventions disclosed herein. The timing chart comprises a first chart 801 illustrating the condition of a switch (such as switch 215, see FIG. 2). The timing chart further comprises a second chart 803 illustrating the operating conditions of a motor (such as electric motor 103; see FIG. 1). The timing chart lasting comprises a third chart 805 illustrating the luminance of an associated LED of the rotary tool (such as LED 223; see FIG. 2). In the depicted embodiment, the motor of the rotary tool engages immediately in response to activation of a switch press. If the switch remains pressed during a first window of time 809, the LED remains in an “off state” 813 until the first window of time 809 expires. In the depicted embodiment, first window of time 809 may comprise a predetermined threshold value of 1-5 seconds, but other embodiments may comprise other configurations without deviating from the teachings disclosed herein. In the depicted embodiment, the first window of time 809 may comprise 3 seconds, but other embodiments may comprise other configurations without deviating from the teachings disclosed herein. After the first window of time 809 is reached, the timer is then monitored for additional time in spans corresponding to a second window of time 811. Once the first window of time 809 is reached while the switch is still pressed, the status of the LED moves from the off condition 813 to the maximum luminance 815. Notably, the status of the motor no longer changes with respect to continued pressing of the switch, as a different input is required to disengage the motor of the rotary tool.

After each successive period of time equivalent to second time window 811 while the switch remains pressed, the illumination state of the LED changes. The changes to illumination occur according to a cycle that shifts at regular intervals of the second time window 811. In the depicted embodiment, the LED cycles through 5 states of illumination, starting with maximum luminance 815. The additional states correspond to shifts in illumination of 20% luminance after each successive second time window 811 has elapsed: a second luminance 817 corresponding to 80% of the maximum brightness, a third luminance 819 corresponding to 60% of the maximum brightness, a fourth luminance 821 corresponding to 40% of the maximum brightness, and a fifth luminance 823 corresponding to 20% of the maximum brightness.

Other embodiments may exhibit different luminance cycles, such as 10% increments, 5% increments, or even uneven incremental changes (such as maximum, 80%, 50%, and 10%) without deviating from the teachings disclosed herein. In the depicted embodiment, the second time window 811 is shorter than the first time window 809, but other embodiments may comprise other configurations having different or equivalent time windows without deviating from the teachings disclosed herein. In the depicted embodiment, second time window 811 may comprise to a 1 second threshold value, but other embodiments may comprise other values without deviating from the teachings disclosed herein. Some embodiments may comprise a second time window 811 in the range of 0.25-5 seconds without deviating from the teachings disclosed herein.

Some embodiments may comprise a cycle having irregular time windows between luminance levels without deviating from the teachings disclosed herein. By way of example, and not limitation, the time window associated with the 80% luminance may be shorter than the time window associated with the 20% luminance without deviating from the teachings disclosed herein.

In the depicted embodiment, if the switch remains pressed after cycling through all the available luminance values 815-823, the next iteration of the cycle returns to maximum luminance 815, but other embodiments may include a return to the off condition 813 or other values without deviating from the teachings disclosed herein. In the depicted embodiment, after 5 iterations of second time window 811, the switch is released, and the luminance setting of the LED remains at maximum luminance 815 until another input is received at the switch. Notably, the motor continues operating without regard for the behaviors of the LED.

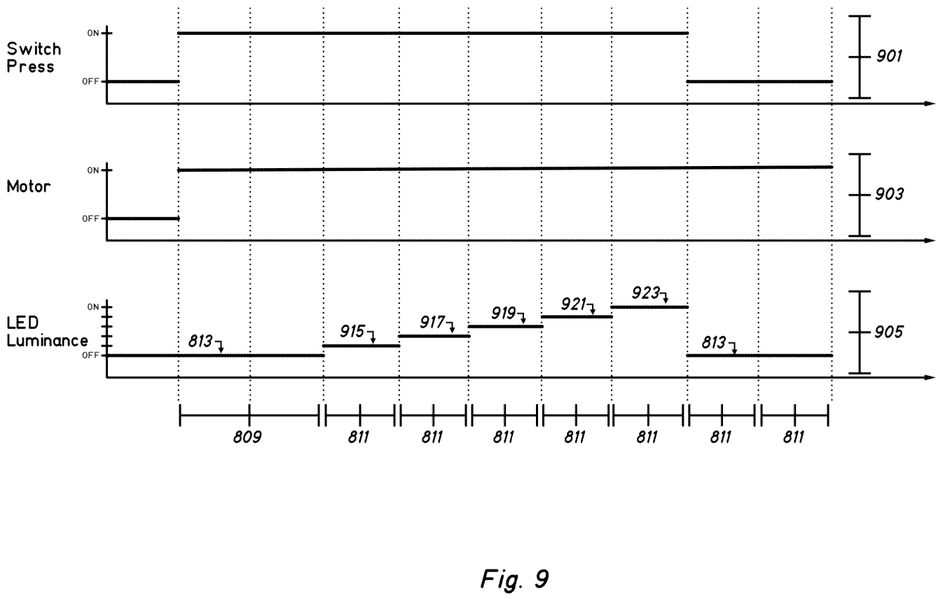

FIG. 9 presents a timing chart illustrating the behavior of a rotary tool (such as rotary tool 100; see FIG. 1) according to an alternative embodiment of the inventions disclosed herein. The timing chart comprises a first chart 901 illustrating the condition of a switch (such as switch 215, see FIG. 2). The timing chart further comprises a second chart 903 illustrating the operating conditions of a motor (such as electric motor 103; see FIG. 1). The timing chart lasting comprises a third chart 905 illustrating the luminance of an associated LED of the rotary tool (such as LED 223; see FIG. 2). In this embodiment, the first window of time 809 and second window of time 811 are used as time threshold values similarly to the embodiment of FIG. 8, but different functions of the LED are illustrated in contrast.

In the depicted embodiment, the motor of the rotary tool engages immediately in response to activation of a switch press. If the switch remains pressed during the first window of time 809, the LED remains in an “off state” 813 until the first window of time 809 expires. In the depicted embodiment, first window of time 809 may comprise a predetermined threshold value of 1-5 seconds, but other embodiments may comprise other configurations without deviating from the teachings disclosed herein. In the depicted embodiment, the first window of time 809 may comprise 3 seconds, but other embodiments may comprise other configurations without deviating from the teachings disclosed herein. After the first window of time 809 is reached, the timer is then monitored for additional time in spans corresponding to a second window of time 811. Once the first window of time 809 is reached while the switch is still pressed, the status of the LED moves from the off condition 813 to the first luminance 915, corresponding to a brightness having 20% of the maximum luminance. Notably, the status of the motor no longer changes with respect to continued pressing of the switch, as a different input is required to disengage the motor of the rotary tool.

After each successive period of time equivalent to second time window 811 while the switch remains pressed, the illumination state of the LED changes. The changes to illumination occur according to a cycle that shifts at regular intervals of the second time window 811. In the depicted embodiment, the LED cycles through 5 states of illumination, starting with 20% luminance 915. The additional states correspond to shifts in illumination of 20% luminance after each successive second time window 811 has elapsed: a second luminance 917 corresponding to 40% of the maximum brightness, a third luminance 919 corresponding to 60% of the maximum brightness, a fourth luminance 921 corresponding to 80% of the maximum brightness, and a fifth luminance 923 corresponding to the maximum brightness.

Other embodiments may exhibit different luminance cycles, such as 10% increments, 5% increments, or even uneven incremental changes (such as maximum, 80%, 50%, and 10%) without deviating from the teachings disclosed herein. In the depicted embodiment, the second time window 811 is shorter than the first time window 809, but other embodiments may comprise other configurations having different or equivalent time windows without deviating from the teachings disclosed herein. In the depicted embodiment, second time window 811 may comprise to a 1 second threshold value, but other embodiments may comprise other values without deviating from the teachings disclosed herein. Some embodiments may comprise a second time window 811 in the range of 0.25-5 seconds without deviating from the teachings disclosed herein.

Some embodiments may comprise a cycle having irregular time windows between luminance levels without deviating from the teachings disclosed herein. By way of example, and not limitation, the time window associated with the 80% luminance may be shorter than the time window associated with the 20% luminance without deviating from the teachings disclosed herein.

In the depicted embodiment, if the switch remains pressed after cycling through all the available luminance values 915-923, the next iteration of the cycle returns to the off condition 813 as the next interval. In the switch remains pressed for another duration of the second time window 811, the cycle would repeat the iterations, returning to first luminance 915 and proceeding through the established cycle as before. Other embodiments may include other values without deviating from the teachings disclosed herein. In the depicted embodiment, after 5 iterations of second time window 811, the switch is released, and the luminance setting of the LED remains in the off condition 813 until another input is received at the switch. Notably, the motor continues operating without regard for the behaviors of the LED.

While exemplary embodiments are described above, it is not intended that these embodiments describe all possible forms of the disclosed apparatus and method. Rather, the words used in the specification are words of description rather than limitation, and it is understood that various changes may be made without departing from the spirit and scope of the disclosure as claimed. The features of various implementing embodiments may be combined to form further embodiments of the disclosed concepts.

1. A rotary tool comprising:
a body;
an electric motor at least partially disposed within the body;
a rotating shaft coupled to the electric motor;
a nosecap having electrical contacts and at least partially surrounding the rotating shaft during operation of the rotary tool; and
a switch in electrical communication with the electrical contacts of the nosecap,
wherein
the electric motor is configured to rotationally drive the rotating shaft, the switch engages and disengages the electric motor,
the nosecap further comprises a light-emitting diode (LED) disposed thereupon, the LED illuminating when the electric motor is engaged, the LED arranged to project light toward a working end of the rotating shaft when illuminated.

2. The rotary tool of claim 1, wherein the nosecap further comprises a plurality of LEDs, each of the plurality of LEDs disposed upon the nosecap and arranged to project light toward the working end of the rotating shaft when illuminated.

3. The rotary tool of claim 2, wherein the plurality of LEDs are arranged at regular intervals along an angular measurement with respect to the rotating shaft.

4. The rotary tool of claim 2, wherein the plurality of LEDs comprises 4 LEDs.

5. The rotary tool of claim 1, wherein the switch is configured to de-illuminate the LED without disengaging the electric motor.

6. The rotary tool of claim 1, wherein the nosecap further comprises a control circuit in electrical communication with the LED, the control circuit governing the behavior of the LED.

7. The rotary tool of claim 6, wherein the control circuit governs the speed with which the LED illuminates and de-illuminates.

8. The rotary tool of claim 7, wherein the control circuit selectively illuminates one or more of the plurality of LEDs in response to toggling of the switch.

9. A method for controlling a light-emitting diode (LED) disposed upon a rotary tool, the method comprising:
applying a voltage to a control circuit in response to the engagement of an electric motor of the rotary tool;
utilizing the voltage to illuminate the LED; and
illuminating the LED after a start condition is detected by the control circuit until a stop condition is detected by the control circuit,
wherein
the engagement of the electric motor is controlled by a switch, and
the control circuit comprises a transistor array.

10. The method of claim 9, wherein the stop condition comprises disengagement of the electric motor.

11. The method of claim 10, wherein the start condition comprises engagement of the electric motor.

12. The method of claim 9, wherein the rotary tool further comprises a switch, and wherein the start condition comprises engaging the switch for less than a threshold value of time.

13. The method of claim 12, wherein the stop condition comprises engaging the switch for at least the threshold value of time.

14. The method of claim 13, wherein the threshold value of time is 3 seconds.

15. A method for controlling a light-emitting diode (LED) disposed upon a rotary tool, the method comprising:
applying a first voltage to a control circuit in response to the engagement of an electric motor of the rotary tool;
applying a second voltage to the LED in response to engagement of a switch; and
adjusting the second voltage in response to continued engagement of the switch,
wherein
the second voltage applied to the LED is adjusted according to predetermined set of voltage values and
the adjustment to the second voltage cycles through the predetermined set of voltage values at regular intervals based upon a timer.

16. The method of claim 15, wherein one of the predetermined set of voltage values comprises a value corresponding to maximum illumination of the LED.

17. The method of claim 15, wherein the predetermined set of voltage values comprises values corresponding to 20% increments of luminance compared to maximum illumination.

18. The method of claim 15, wherein the predetermined set of voltages comprises a set of voltages corresponding to maximum luminance, 80% luminance, 60% luminance, 40% luminance, and 20% luminance.

19. The method of claim 18, wherein the predetermined set of voltages comprises an additional voltage corresponding to an off condition of the LED.

20. The method of claim 15, wherein the regular intervals are a specified time within a range of 1-5 seconds.
